(19) United States
(12) Patent Application Publication
(10) Pub. No.: US 2012/0298454 A1
(43) Pub. Date: Nov. 29, 2012

(54) Brake Pad Retention System

(75) Inventor: Ronald S. PLANTAN, Elyria, OH (US)

(73) Assignee: Bendix Spicer Foundation Brake LLC, Elyria, OH (US)

(21) Appl. No.: 13/116,500

(22) Filed: May 26, 2011

(51) Int. Cl. F16D 65/097; F16D 55/22; F16D 55/225; F16D 65/092

(52) U.S. Cl. 188/72.1; 188/234; 188/73.38

(57) ABSTRACT

An improved approach to brake pad retention within a brake caliper is provided by a brake pad and brake caliper system in which brake pad retention features are provided on one of the brake pad or the caliper, with corresponding holes for receiving the retention features being provided on the corresponding pad or caliper part. The retention feature may be pin affixed to or integrally formed with the brake pad backing plate, about which a self-retaining spring bushing is located. The spring bushing and the corresponding retention feature receiving hole are sized so that the spring bushing is radially compressed when the brake pad is installed in the brake caliper by an amount sufficient to retain the brake pad in the caliper while still allowing the brake pad to move tangentially as necessary to transfer braking torque to the axle on which the caliper is mounted.

### BACKGROUND AND SUMMARY OF THE INVENTION

The present invention relates to brake pads used in, for example, air disk brakes on commercial vehicle axles. More specifically, the present invention relates to a new approach to brake pad retention within a brake caliper.

Prior art brake pads, particularly brake pads in commercial vehicle air disk brake applications, commonly have been installed in brake calipers in recesses which support the brake pads, with separate pad retaining mechanisms thereafter being installed to prevent release of the brake pad from the caliper. These separate retention mechanism typically are attached to, and/or rely on interaction with, the brake caliper in order to retain the brake pad in position in the caliper. Examples of such separate retention mechanisms include brake pad hold-down springs, cross-pins which pass over and/or through the brake pad, leaf springs which bear against the brake pad backing plate, and brake pad hold-down bars.

As commercial vehicle air disk brakes become more widely adopted in the U.S., new applications for these brakes result in demands for brake arrangements in a variety of positions about the circumference of the brake rotor to accommodate individual truck axle end designs. For example, where one steerable axle end may position a steering tie rod end below the center of the axle, another axle end may have the steering tie rod end located above the center of the axle. As a result of the latter, it may be necessary to locate the brake caliper in the area below the center of the axle to provide sufficient clearance to other axle components. A problem with “hanging” a caliper having conventional brake pad retention features below the axle center (for example, in a position in the lower quadrant of the brake disk, i.e., between approximately 4 o'clock and 8 o'clock) is that in some cases severe operating conditions (e.g., severe vibration) may lead to excessive wear on the pad, the pad retention system, and/or the caliper itself, and may ultimately result in the brake pad become dislodged, thereby disabling the brake.

In view of the foregoing, it is an objective of the present invention to provide an improved brake pad retentions system, in which weight, cost, ease of manufacture, installation and maintenance are improved over prior brake pad retention designs. In addressing these and other objects, the present invention solves the brake pad retention problems of the prior art by use of a brake pad retention arrangement which eliminates the need for separate caliper-mounted retention components to secure the brake pad within the caliper, provides positive retention of the brake pad regardless of caliper orientation about an axle, and simplifies and lowers the costs of brake pad manufacture, installation and maintenance.

In one embodiment of the present invention, a brake pad is provided with at least one retaining element, in this embodiment two pins protruding from a caliper side of the brake pad backing plate, and corresponding spring bushings (also referred to as spring sleeves) which engage the protruding pins. The spring bushings are provided to engage corresponding holes in the caliper so as to lock the brake pad into place without the need for other separate brake pad retention components. Such an arrangement provides improved brake pad retention in high brake torque and high vibration conditions and, by providing improved position control, may decrease the amount of wear by the brake pad backing plate on the brake pad abutment on the carrier through which the brake pad transfers braking torque between the wheel and the rest of the vehicle.

The retention pins may be formed and/or attached to the brake pad backing plate in any suitable manner which provides positive connection to the backing plate. For example, the pins may be separate components which are attached to the backing plate by a method such as welding. Alternatively, the pins may be formed from the plate material itself, for example by stamping, with the desired pin head shape being formed by suitable mandrels.

The present brake pad retention approach may include further features, such as the inclusion of a vibration- and noise-suppressing element between the pin and the spring sleeve. Preferably, such an element would be retained between the pin and the spring sleeve by these components themselves without the need for a separate retaining device. It also would be preferred that the suppression element would not substantially limit the ability of the pin to move within the spring sleeve.

In addition to the embodiment in which the brake pad pins and spring bushings engage corresponding holes in the caliper so as to lock the brake pad into place, in applications where the necessary caliper structure is not present immediately adjacent to the brake pad, for example, on an actuator side of the caliper, a torque bar (“T-bar”) may be provided. Such a bar may be shaped to bridge a gap between the caliper arms to provide a rotationally- and circumferentially-fixed plate having holes to receive the brake pad backing plate pin and spring sleeve to hold the brake pad, which still permitting axial movement (for example, in response to application of pressure pieces of a brake actuator to push the brake pad against a brake rotor) and permitting the brake pad backing plate to transfer braking torque to the vehicle axle.

Advantages of the present invention include cost and weight elimination by the elimination of separate prior art brake pad retention components. In addition, by simplifying the configuration of the brake pad retention features, assembly of brake pads into a brake caliper and subsequent removal of the brake pads by a technician are substantially simplified, decreasing caliper assembly and maintenance costs. Brake pad manufacturing costs are also reduced as a result of the simplified pad retention structure.

Other objects, advantages and novel features of the present invention will become apparent from the following detailed description of the invention when considered in conjunction with the accompanying drawings.

### BRIEF DESCRIPTION OF THE DRAWINGS

FIG. 1 is an oblique view of a brake pad in accordance with an embodiment of the present invention.

FIG. 2 is a cross-section view a detail of a brake pad retention feature of the FIG. 1 embodiment through section A-A of FIG. 1.

FIG. 3 is a cross-section view of an alternative embodiment of the brake pad retention feature which may be used with the FIG. 1 brake pad.

FIG. 4 is an elevation view of a brake pad retaining bar located on an actuator side of a brake caliper to provide brake pad retention bushing receiving holes in accordance with another embodiment of the present invention.

### DETAILED DESCRIPTION OF THE DRAWINGS

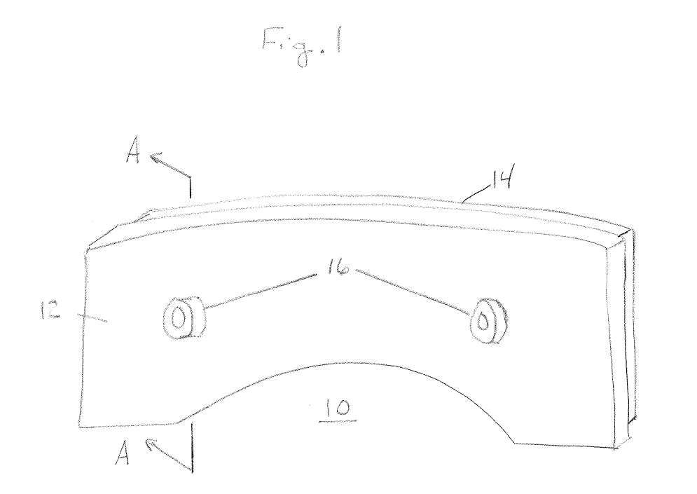

FIG. 1 is an oblique view of a brake pad 10. The brake pad backing plate 12 supports pad material 14 on a brake disc-side of brake pad 10. On a caliper-side of the backing plate 12 are located two brake pad retention features 16, details of which are discussed further, below.

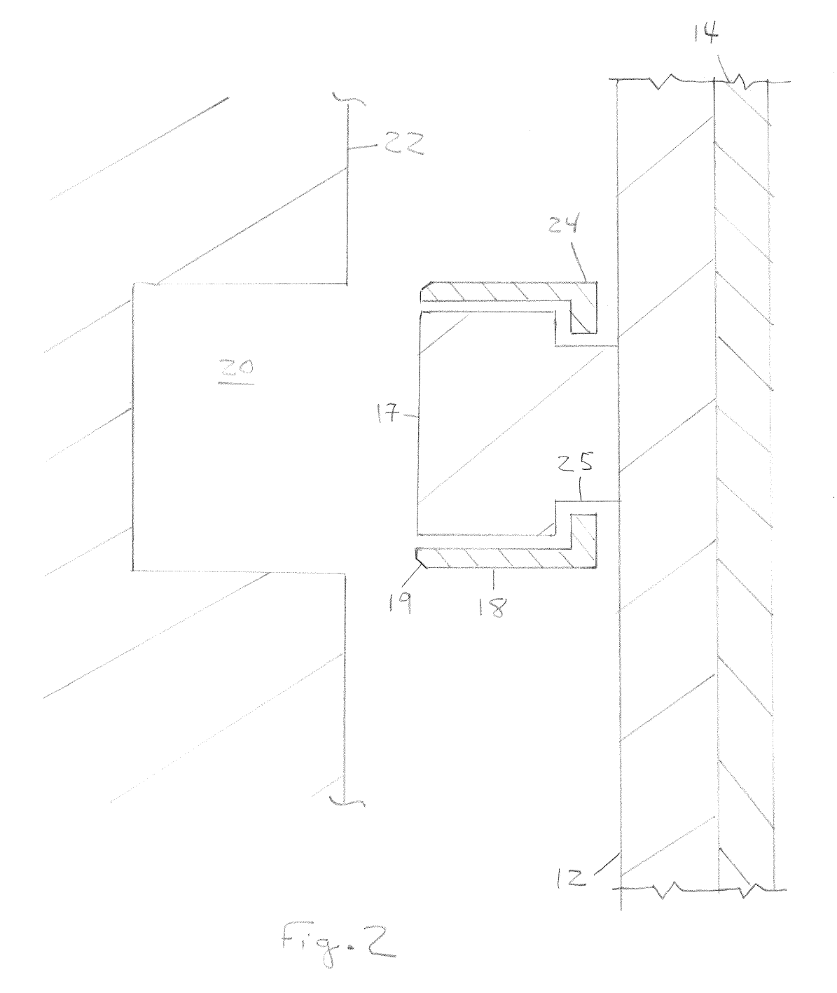

FIG. 2 shows a cross-section view a detail of a brake pad retention feature of the FIG. 1 embodiment through section A-A of FIG. 1. In this view, brake pad backing plate 12 has on its caliper side (the side away from pad material 14, comprising stepped pin 17 and retention spring sleeve 18. The retention feature is illustrated aligned with a receiving hole 20 in the face of schematically illustrated caliper port 22.

The retention spring sleeve 18 is a generally cylindrical sleeve which may be radially expanded (for example, by inclusion of an axial slot on one side of the sleeve or overlapping circumferential end sleeve wall faces) to allow the sleeve to be elastically expanded to be installed over the stepped pin 17. The stepped pin 17 has a reduced diameter section 25 which receives an axially-inward facing sleeve flange 24, arranged such that after the retention spring sleeve 18 is expanded, placed over stepped pin 17 and released, the spring elastically contracts such that sleeve flange 24 prevents removal of sleeve 18 from the stepped pin.

The inner diameter of the retention spring sleeve 18 and the maximum outer diameter of the stepped pin 17 are selected to provide free radial movement of the sleeve about the pin. The sleeve flange 24 is similarly sized so as to not constrain radial movement of the sleeve. The respective inner and outer diameters of the sleeve and stepped pin are also selected to permit the outer diameter of the retention spring sleeve to be reduced to a small enough outer diameter to allow the retention feature to be inserted into the hole 20 in caliper part 22. A beveled edge 19 may be provided about the outer circumference of the caliper end of the retention spring sleeve 18 to aid in insertion of the sleeve into the caliper hole 20.

The caliper hole 20 is sized such that when the retention spring sleeve 18 is inserted, a radially compressive load is maintained on the spring sleeve 18 to preclude removal of the retention feature from the hole 20 during brake operations. Conversely, the caliper hole 20 should also be sized so that when the brake pad is replaced, the retention spring sleeve 18 may be easily removed by a technician.

Another caliper hole size consideration relates to the motion of the brake pad during brake operation. Preferably, the caliper hole 20 is not sized so small in diameter that the spring sleeve 18 is compressed to the point of removing all clearance between the sleeve and the stepped pin 17. By maintaining clearance between the spring sleeve 18 and stepped pin 17, the slight radial movement capability provided between the pin and the sleeve allows the brake pad to be effectively retained in the caliper by the retention spring sleeve 18, while still allowing the stepped pin 17 to be free to move slightly in the radial direction to permit the brake pad to make corresponding small position movements as needed to accommodate various braking-induced forces.

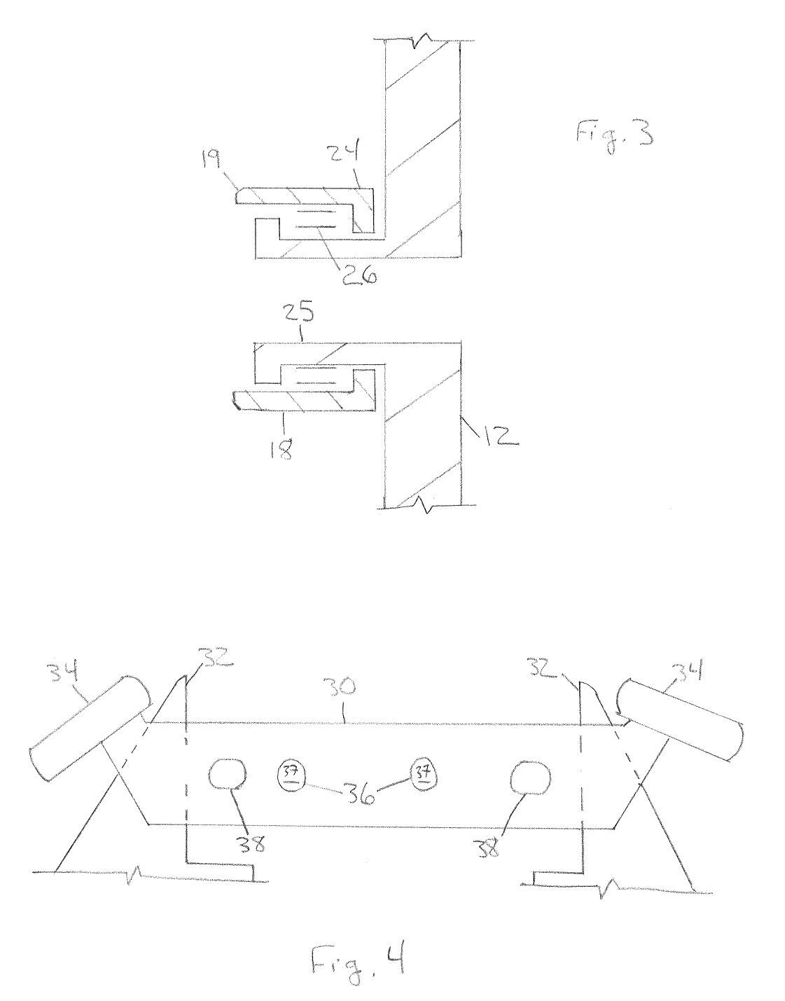

FIG. 3 shows a cross-section view of an alternative embodiment of the brake pad retention feature. In this embodiment, the stepped pin 17 is not attached to the brake pad backing plate 12 (shown in this figure without pad material 14), but is formed from the backing plate material, for example by an extrusion process. The stepped pin 17's reduced diameter section 25 in FIG. 3 is axially longer than in the FIG. 1 embodiment, providing a relatively deep annulus between the stepped pin and the spring sleeve 18, in which an anti-rattle spring 26 may be accommodated. This embodiment is functionally the same as the FIG. 1 embodiment, in that as the retaining feature is inserted into the caliper hole, the spring sleeve 18 is radially compressed (aided by bevel 19) and retained by the compressive forces generated by the caliper hole walls.

FIG. 4 is an elevation view of an alternative embodiment of a brake pad mounting arrangement in accordance with an embodiment of the present invention. In this embodiment, the retention features are not inserted into and retained by holes 20 in the caliper body. In this embodiment a pad mounting torque reaction bar 30 (a “T-bar”) is provided in an area on the brake actuator-side of the caliper, where brake pad carrier horns 32 are located. The T-bar 30 here spans the gap between opposing caliper arms 34. The T-bar is provided with features (in this embodiment, hole 36) which engage brake actuator pins 37 of an adjacent brake actuator. The T-bar is also provided with brake pad retention feature receiving holes 38 to receive and thereby retain the brake pad retention features 16 of brake pad 10. As shown in FIG. 4, the brake pad retention feature receiving holes 38 may be formed as elongated holes to accommodate brake pad manufacturing variations and brake pad movement during brake operation as the brake pad abuts the carrier horns to transfer braking torque to the brake carrier. This arrangement permits the T-bar 30 to connect the actuators to the brake pad to advance the brake pad toward the brake disc during braking, while also limiting (by virtue of the T-bar's extending out to the caliper arms) a torque reaction that may occur as the caliper abutment wears.

It is preferable that the brake pad retention features are spaced toward the lateral outside edges of the brake pad backing plate for pad stability. Preferably, brake pad retention features are located inboard of the lateral outer edge of the brake pad backing plate at a distance of approximately 5% to 20% of the lateral width of the backing plate.

The foregoing disclosure has been set forth merely to illustrate the invention and is not intended to be limiting. For example, one of skill in the art would recognize that the pin and spring sleeve arrangements might be reversed, such that the pin and spring sleeve are located on caliper components and the receiving holes are located in the brake pad backing plate. Because other such modifications of the disclosed embodiments incorporating the spirit and substance of the invention may occur to persons skilled in the art, the invention should be construed to include everything within the scope of the appended claims and equivalents thereof.

What is claimed is:

1. A disk brake pad, comprising:
a brake pad backing plate, the brake pad backing plate having a pad material side to which brake pad friction material is affixed and a caliper side opposite the pad material side; and
at least one brake pad retention feature located on the caliper side of the brake pad backing plate, the at least one brake pad retention feature including at least one brake pad retaining element and a corresponding spring bushing retained on the at least one brake pad retaining element,
wherein the spring bushing is arranged to be self-retaining when located on the at least one brake pad retaining element with radial clearance between the spring bushing and the at least one brake pad retaining element to permit radial compression of the spring bushing around the at least one retaining element when the brake pad is in an installed position in a brake caliper.

2. The disk brake pad according to claim 1, wherein
the at least one brake pad retaining element is at least one retaining pin.

3. The disk brake pad according to claim 2, wherein
the at least one retaining pin is one of formed integrally with the brake pad backing plate or is affixed to the brake pad backing plate.

4. The disk brake pad according to claim 3, further comprising:
a torque bar, wherein the torque bar is arranged to span a circumferential gap of a brake caliper between calipers arms and is provided with retention feature receiving holes corresponding to each of the at least one brake pad retention features on the brake pad backing plate.

5. The disk brake pad according to claim 4, wherein the torque bar retention feature receiving holes are sized to radially compress the spring bushing when the brake pad is in an installed position in the torque bar.

6. The disk brake pad according to claim 1, wherein each of the at least one brake pad retention feature is located inboard of a lateral outer edge of the brake pad backing plate at a distance of 5% to 20% of a lateral width of the brake pad backing plate.

7. A disk brake, comprising:
a brake caliper; and
a first brake pad,
wherein the first brake pad includes
a brake pad backing plate, the brake pad backing plate having a pad material side to which brake pad friction material is affixed and a caliper side opposite the pad material side, and
at least one brake pad retention feature located on the caliper side of the brake pad backing plate, the at least one brake pad retention feature including at least one brake pad retaining element and a corresponding spring bushing retained on the at least one brake pad retaining element, the spring bushing being arranged to be self-retaining when located on the at least one brake pad retaining element with radial clearance between the spring bushing and the at least one brake pad retaining element to permit radial compression of the spring bushing around the at least one retaining element when the brake pad is in an installed position in the brake caliper, and.
wherein the brake caliper includes retention feature receiving holes corresponding to the brake pad retention features on the brake pad backing plate, the retention feature receiving holes being sized to radially compress the spring bushing when the brake pad is in an installed position in the brake caliper.

8. The disk brake according to claim 7, further comprising:
a torque bar; and
a second brake pad,
wherein the torque bar is arranged to span a circumferential gap of the brake caliper between calipers arms on an actuator side of the brake caliper and is provided with additional retention feature receiving holes arranged to receive retention features of the second brake pad.

9. The disk brake according to claim 7, wherein
the at least one brake pad retaining element is at least one retaining pin.

10. The disk brake according to claim 9, wherein
the at least one retaining pin is one of formed integrally with the brake pad backing plate or is affixed to the brake pad backing plate.

11. The disk brake according to claim 7, wherein each of the at least one brake pad retention feature is located inboard of a lateral outer edge of the brake pad backing plate at a distance of 5% to 20% of a lateral width of the brake pad backing plate.

12. A disk brake caliper, comprising:
a brake caliper body having an actuator side and an opposing side; and
a brake actuator located on the actuator side of the brake caliper body,
wherein
the brake caliper body is arranged to straddle a brake disk when in an installed position, and
the brake caliper body includes at least one brake pad retaining hole arranged to receive a brake pad retaining feature of a brake pad, the at least one brake pad retaining hole being sized to radially compress a spring bushing of the brake pad retaining feature when the brake pad is in an installed position in the brake caliper.

13. The disk brake caliper according to claim 12, further comprising:
a torque bar,
wherein the torque bar is arranged to span a circumferential gap of the brake caliper between calipers arms on the actuator side of the brake caliper and is provided with additional retention feature receiving holes arranged to receive brake pad retention features.
